(19) United States
(12) Patent Application Publication
(10) Pub. No.: US 2006/0066793 A1
(43) Pub. Date: Mar. 30, 2006

(54) Liquid crystal display device

(75) Inventors: Katsufumi Ohmuro, Kawasaki (JP); Hideaki Tsuda, Kawasaki (JP); Shingo Kataoka, Kawasaki (JP); Jin Hirosawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU DISPLAY TECHNOLOGIES CORPORATION

(21) Appl. No.: 11/058,562

(22) Filed: Feb. 15, 2005

(30) Foreign Application Priority Data
Sep. 24, 2004 (JP) 2004-278069

(51) Int. Cl. G02F 1/1337

(52) U.S. Cl. 349/129

(57) ABSTRACT

A high-performance liquid crystal display device is provided that can be manufactured at a low cost and a high production yield. In this liquid crystal display device, a liquid crystal composition comprising liquid crystal molecules and a polymerizable compound that can be polymerized by ultraviolet rays or by a combination of ultraviolet rays and heat is disposed between a pair of substrates; the polymerizable compound is polymerized, forming a liquid crystal layer, by an operation including irradiation of ultraviolet rays that do not contain wavelength components of not higher than 313 nm; and uneven portions are installed on the liquid crystal layer contacting surface, or a slit pattern is installed in an electrode, or uneven portions are installed on the liquid crystal layer contacting surface, and a slit pattern is installed in the electrode.

### CROSS-REFERENCE TO RELATED APPLICATIONS

This application is based upon and claims the benefit of priority from the prior Japanese Patent Application No. 2004-278069, filed on Sep. 24, 2004, the entire contents of which are incorporated herein by reference.

### BACKGROUND OF THE INVENTION

1. Field of the Invention

The present invention relates to a liquid crystal display device.

2. Description of the Related Art

In recent years, widely used as liquid crystal display devices (LCD's) using active matrices are liquid crystal display devices according to the TN mode in which a liquid crystal material having a positive dielectric constant anisotropy is aligned horizontally along the surface of two substrates facing each other with twisting at an angle of 90° between the substrates. However, this TN mode has a problem of poor viewing angle properties, and various investigations have been made to improve the viewing angle properties.

An MVA (Multi-domain Vertical Alignment) mode has been developed as an alternative, in which an n-type liquid crystal having a negative dielectric constant anisotropy is vertically aligned, and the tilting direction of the liquid crystal molecules is controlled through the control of electric field by uneven portions formed on the surface of substrates and/or by patterns in a transparent electrode (see Japanese Unexamined Patent Application Publication No. H11-95221 (claims), H8-338993 (claims), H5-232465 (claims), and H08-036186 (EXAMPLE 1), for example).

As one of causes to decrease the production yield in the production of the MVA liquid crystal panels, there is a problem of defects generated during the process for forming alignment layers. As one of serious defects from the viewpoint of materials for use, there is a problem of cissing or dewetting of the alignment layer material caused by the uneven portions on the substrate surface. This cissing or dewetting phenomenon tends to occur in the protruding parts of protrusions or the like formed on the substrate surface, with the result that the alignment layers become thinner in such portions, making vertical alignment difficult. Furthermore, as a problem of facilities, the technology to print alignment layers itself finds difficulty in accommodating the current large substrates. Accordingly, it is more and more difficult to manufacture large substrates requiring alignment layers at a high production yield.

As one technique to solve the above-described problems, polymer dispersion-type liquid crystals have long been studied and developed, in which liquid crystal display devices that do not need alignment layers are realized by mixing a photopolymerizable monomer with a liquid crystal, disposing the mixture between substrates, and irradiating ultraviolet rays.

However, this system has not proved to be practical, with various issues such as low contrast ratio and high driving voltage. To improve this system, a reverse-mode polymer dispersion-type liquid crystal system has been reported in which the liquid crystal molecules are vertically aligned at the initial alignment (see, for example, “the 17th liquid crystal discussion, drafts for lecture, p. 328). This system realizes a VA alignment without using alignment layers.

Furthermore, the ECB system using a polarizing plate having an excellent display quality has been also proposed, while the above-described system is a dispersion system with a low contrast ratio (see Japanese patent No. 2881073 (claims), for example). However, in this system, the liquid crystal material in the polymer must have a negative dielectric constant anisotropy and must be able to be driven at two frequencies, which is not common. Furthermore, the production processes are complicated, including the necessity to align the liquid crystal under a magnetic field. Accordingly, it is not a practical technology.

Furthermore, among the improvements of known technologies, there is one disclosed in Japanese Unexamined Patent Application Publication No. H11-95221 (claims). Regarding this technology, it is the same as the known technologies in the way of mixing a photopolymerizable monomer with a liquid crystal. By activating the substrate with heating or ultraviolet ray irradiation, a vertical alignment is realized, utilizing the property that the monomer and the liquid crystal are phase-separated from each other, and the monomer is spontaneously adsorbed onto the surface of the substrate, when the mixture of liquid crystal and monomer is left standing in a sealed state. Furthermore, the adsorbed monomer on the surface of the substrate is polymerized by irradiation with ultraviolet rays in a range of 180-400 nm. At this moment, the alignment direction of the liquid crystal molecules is regulated by irradiation at a slant with parallel ultraviolet rays.

However, it was found difficult to realize a stable alignment, in this system. Particularly, in this system utilizing spontaneous adsorption, if a mixture of a liquid crystal and a monomer is filled into a liquid crystal panel having a common size, adsorption to the surface of the substrate occurs during the filling, and the ratio of the monomer to the liquid crystal changes according to the location to which the mixture is filled. The difference between the monomer concentration near the injection port and the monomer concentration near the location that is opposite to the injection port is particularly large. After the ultraviolet ray irradiation, this concentration difference results in a problem of display unevenness.

Furthermore, if the surface of a substrate is activated by ultraviolet ray irradiation in the same way as this technology, the mixing ratio of the monomer to the liquid crystal changes during the filling, probably owing to the adsorption phenomenon onto the substrate surface, and there occurs a fluctuation in the thickness of the polymer film after the ultraviolet ray irradiation. This will cause fluctuation of display characteristics and display unevenness across the panel.

The present invention is directed to solving these problems, and providing a high-performance liquid crystal display device that can be manufactured at a low cost and high production yield. Other objects and advantages of the present invention will be clarified by the following explanation.

### SUMMARY OF THE INVENTION

According to one aspect of the present invention, provided is a liquid crystal display device, wherein: a liquid crystal composition comprising liquid crystal molecules and a polymerizable compound that can be polymerized by ultraviolet rays or by a combination of ultraviolet rays and heat is disposed between a pair of substrates; the polymerizable compound is polymerized, forming a liquid crystal layer, by an operation comprising irradiation of ultraviolet rays that do not contain wavelength components of not higher than 313 nm; and protrusions, recessions, or protrusions and recessions are installed on a liquid crystal layer contacting surface, or a slit pattern is installed in an electrode, or protrusions, recessions, or protrusions and recessions are installed on the liquid crystal layer contacting surface, and a slit pattern is installed in the electrode.

By the present invention, a high-performance liquid crystal display device that can be manufactured at a low cost and high production yield, is realized.

Preferred are that a voltage is applied to the liquid crystal molecules at the time of ultraviolet ray irradiation; that the structure of the liquid crystal layer contacting surface and the constitution of the liquid crystal composition are selected, so that when the liquid crystal composition is disposed between the substrates, the adsorption of a polymer formed by polymerization of the polymerizable compound to the liquid crystal layer contacting surface occurs after the ultraviolet ray irradiation, while the adsorption of the polymerizable compound to the liquid crystal layer contacting surface is hard to occur prior to the ultraviolet ray irradiation; that a resin film is disposed, and the surface is used as the liquid crystal layer contacting surface, so that when the liquid crystal composition is disposed between the substrates, the adsorption of a polymer formed by polymerization of the polymerizable compound to the liquid crystal layer contacting surface easily occurs after the ultraviolet ray irradiation, while the adsorption of the polymerizable compound to the liquid crystal layer contacting surface is hard to occur prior to the ultraviolet ray irradiation; that the liquid crystal composition is filled into the space between the substrates in a heated state when disposing the liquid crystal composition between the substrates; that a mixture of a monofunctional monomer and bifunctional monomer is used as the polymerizable compound; that a mixture in which the molar concentration of the monofunctional monomer is higher than that of the bifunctional monomer, is used; that the operation including the ultraviolet ray irradiation, includes ultraviolet ray irradiation and a heat treatment thereafter; that the operation including the ultraviolet ray irradiation, includes a second ultraviolet ray irradiation after the heat treatment; that the liquid crystal molecules have different switching characteristics (voltage-transmittance characteristics) within one pixel; that at least one condition selected from the group consisting of compositional conditions of the polymerizable compound, ultraviolet ray irradiation conditions, voltage application conditions, heat treatment conditions, and formation conditions of a resin film according to the present invention is changed within one pixel; and that the liquid crystal molecules have a negative dielectric constant anisotropy.

By the present invention, a high-performance liquid crystal display device that can be manufactured at a low cost and high production yield, is realized.

### BRIEF DESCRIPTION OF THE DRAWINGS

FIG. 1A is a schematic perspective view showing the alignment of liquid crystal molecules in a liquid crystal panel according to the MVA mode;

FIG. 1B is a schematic perspective view showing the alignment of liquid crystal molecules in a liquid crystal panel according to the MVA mode;

FIG. 2 is a schematic plan view showing directions of alignment of liquid crystal molecules in a liquid crystal panel of a liquid crystal display device according to the MVA mode;

FIG. 3 is a graph indicating the influence of the wavelength and intensity of ultraviolet rays on the voltage holding ratio;

FIG. 4 is another graph indicating the influence of the wavelength and intensity of ultraviolet rays on the voltage holding ratio;

FIG. 5A is a picture showing the result of observation of a liquid crystal panel in a cross-Nicol arrangement after the filling of a liquid crystal composition;

FIG. 5B is another picture showing the result of observation of a liquid crystal panel in a cross-Nicol arrangement after the filling of a liquid crystal composition;

FIG. 6A is another picture showing the result of observation of a liquid crystal panel in a cross-Nicol arrangement after the filling of a liquid crystal composition;

FIG. 6B is another picture showing the result of observation of a liquid crystal panel in a cross-Nicol arrangement after the filling of a liquid crystal composition;

FIG. 7 is a picture showing an example of a slit pattern of an ITO electrode in a liquid crystal panel;

FIG. 8A is another picture showing the result of observation of a liquid crystal panel in a cross-Nicol arrangement after the filling of a liquid crystal composition;

FIG. 8B is another picture showing the result of observation of a liquid crystal panel in a cross-Nicol arrangement after the filling of a liquid crystal composition;

FIG. 8C is another picture showing the result of observation of a liquid crystal panel in a cross-Nicol arrangement after the filling of a liquid crystal composition;

FIG. 9 is a picture showing states of black and white displays in a liquid crystal panel;

FIG. 10 is a graph showing the relationship between the brightness and response speed of liquid crystal panels;

FIG. 11 is a graph showing the voltage-transmittance characteristics of liquid crystal panels;

FIG. 12 is another graph showing the voltage-transmittance characteristics of liquid crystal panels;

FIG. 13 is a schematic view showing exemplary slit patterns of an electrode according to the present invention; and

FIG. 14 is a graph showing the optical characteristics of liquid crystal panels manufactured, using an electrode structure of f in FIG. 13.

### DESCRIPTION OF THE PREFERRED EMBODIMENTS

Embodiments according to the present invention will now be described below, using drawings, examples, etc. These drawings, examples, etc., and descriptions are for demonstrating the present invention, and do not limit the scope of the invention. Needless to say, other embodiments can be included in the scope of the present invention as long as they conform to the essential character according to the present invention.

In the liquid crystal display device according to the present invention, the MVA (Multi-domain Vertical Alignment) mode is employed wherein: protrusions, recessions, or protrusions and recessions are installed on the liquid crystal layer contacting surface; or a slit pattern is installed in an electrode; or protrusions, recessions, or protrusions and recessions are installed on the liquid crystal layer contacting surface, and a slit pattern is installed in the electrode (the phrase “protrusions, recessions, or protrusions and recessions” will be also simply referred to as “uneven portions”, hereafter). Through this, a plurality of alignment directions of liquid crystal molecules can be formed in a pixel, by the electric field applied to the liquid crystal molecules.

Here, it is to be noted that the “liquid crystal layer contacting surface” according to the present invention does not necessarily mean the surface of a simple substrate. It means the surface of a layer that the liquid crystal layer actually contacts. For example, when a substrate and a liquid crystal layer are layered with a transparent electrode (ITO) layer in between, and the liquid crystal layer actually contacts the surface of the transparent electrode (ITO), but not the surface of the substrate, the “liquid crystal layer contacting surface” according to the present invention means the surface of the transparent electrode (ITO) that the liquid crystal molecules contact. If the surface of the transparent electrode (ITO) has been subjected to a treatment to give hydrophilicity, for example, the treated surface is the liquid crystal layer contacting surface. The phrase “liquid crystal layer” is applied to the case not only after but also before the polymerizable compound according to the present invention has been polymerized.

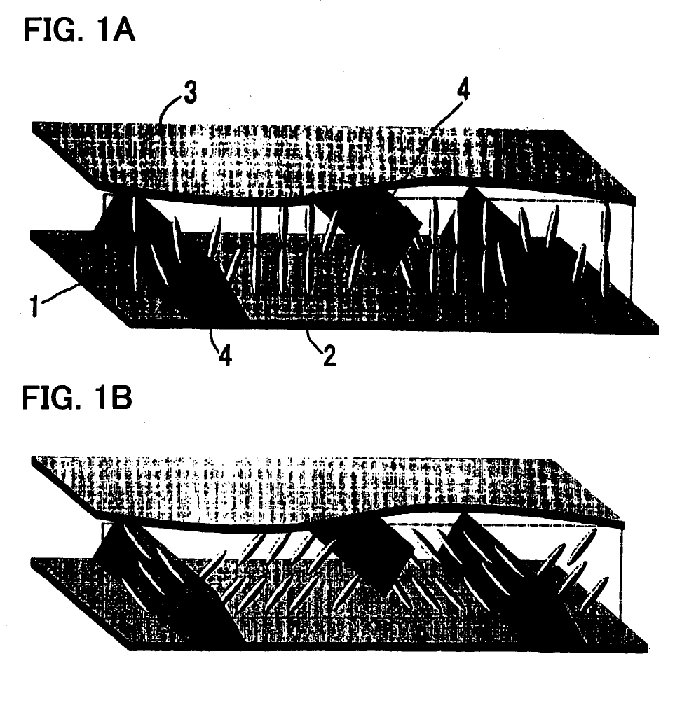

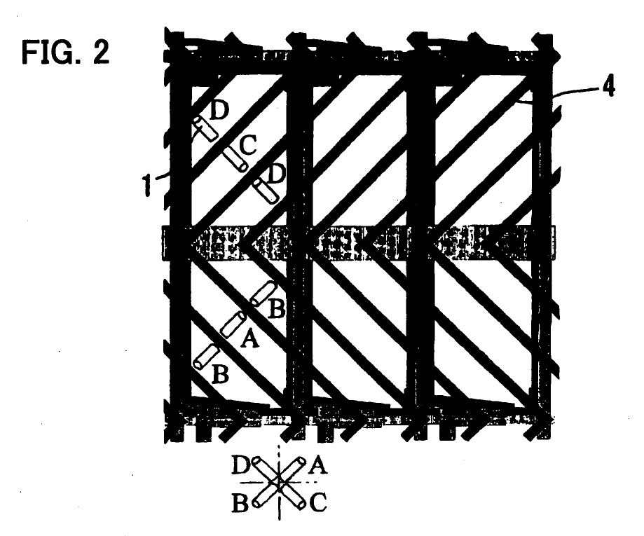

MVA-mode liquid crystal panels are explained using the examples of FIG. 1A, FIG. 1B, and FIG. 2. FIG. 1A and FIG. 1B are schematic perspective views showing the alignment of liquid crystal molecules in the liquid crystal panel of an MVA-mode liquid crystal display device, and FIG. 2 is a schematic plan view showing the alignment directions of liquid crystal molecules in the liquid crystal panel of an MVA-mode liquid crystal display device.

In the liquid crystal panel of this MVA-mode liquid crystal display device, the liquid crystal molecules 1 with a negative dielectric constant anisotropy which are between the two glass substrates are aligned vertically as shown in FIG. 1A when no voltage is applied. Pixel electrodes connected to TFT's (thin film transistors, not shown) are formed on one of the glass substrates 2, and a counter electrode is formed on the other glass substrate 3. Uneven portions 4 are formed in alternation on the pixel electrodes and on the counter electrode, respectively.

When a TFT is in the off state, that is, when no voltage is applied, the liquid crystal molecules are aligned in the direction vertical to the substrate interface, as shown in FIG. 1A. When the TFT is put into the on state, that is, when a voltage is applied, the influence of the electric field causes the liquid crystal molecules to be tilted towards the horizontal direction, and due to the structures of the uneven portions, the tilting direction of the liquid crystal molecules 1 is regulated. As a result, the liquid crystal molecules are aligned in a plurality of directions within one pixel, as shown in FIG. 1B. For example, when uneven portions 4 are formed as shown in FIG. 2, liquid crystal molecules 1 are aligned in each of the directions A, B, C and D. Thus in an MVA-mode liquid crystal display device, with a TFT in the on state, the liquid crystal molecules are aligned in a plurality of directions, and satisfactory viewing-angle characteristics are obtained.

In a liquid crystal display device according to the present invention, a liquid crystal composition comprising liquid crystal molecules and a polymerizable compound that can be polymerized by ultraviolet rays or by a combination of ultraviolet rays and heat is disposed between a pair of substrates, and the polymerizable compound is polymerized, forming a liquid crystal layer, during which ultraviolet rays that do not contain wavelength components of not higher than 313 nm, are irradiated. By this, it is possible to improve the reliability of the liquid crystal display device, and a low cost and a high production yield can be realized in the production.

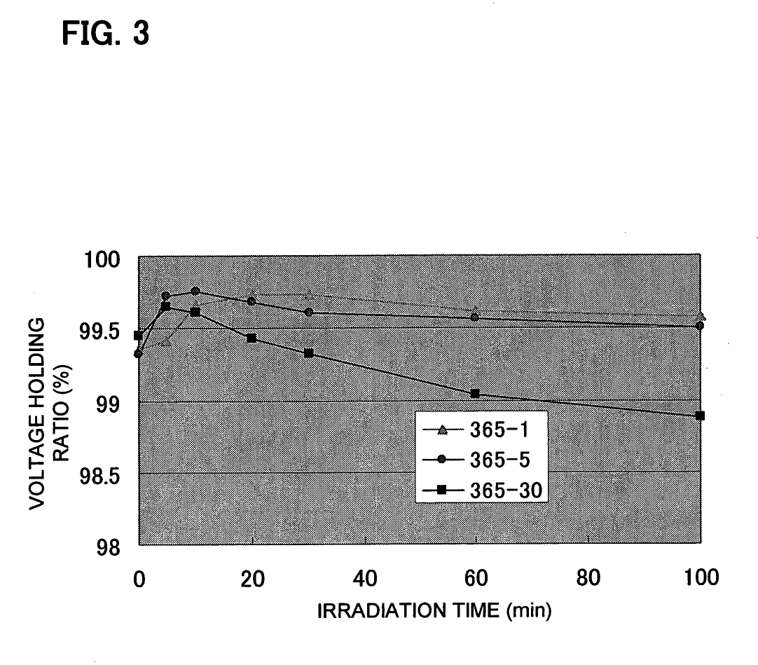

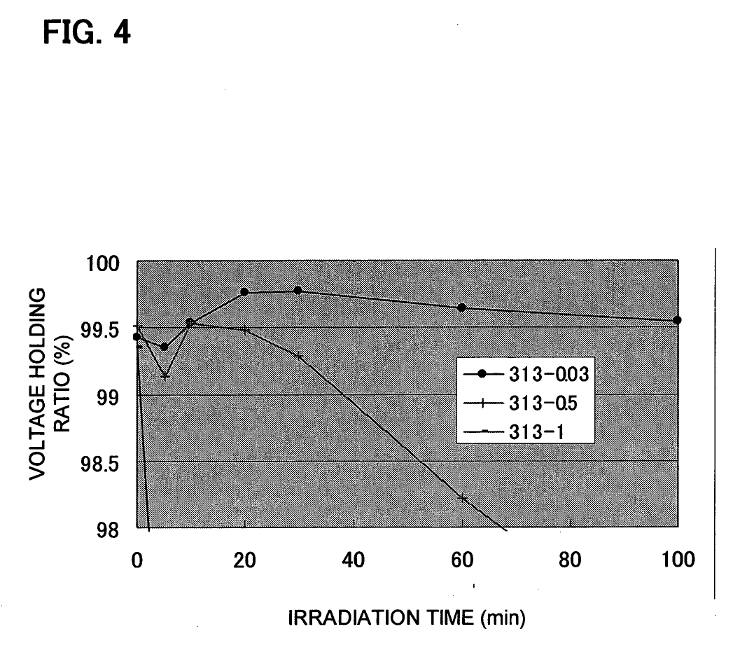

The results of investigation of the effect of ultraviolet ray irradiation are shown in FIGS. 3 and 4. FIGS. 3 and 4 are the results of study of the effect of the wavelength and intensity of ultraviolet rays on the voltage holding ratio (VHR) (the ratio of the voltage obtained 16.7 ms after the cease of a voltage application to the applied voltage), an important indicator for the level of reliability. FIG. 3 shows the results when ultraviolet rays in a 365 nm band were irradiated for 1 mW (▴(solid triangle)), 5 mW (●(solid circle)), and 30 mW (▪(solid square)), and FIG. 4 shows the results when ultraviolet rays in a 313 nm band were irradiated for 0.03 mW (●(solid circle)), 0.5 mW (+), and 1 mW (−).

From FIGS. 3 and 4, it is understood that when the ultraviolet rays in the 365 nm band were used for the present invention, peaks in the VHR could be obtained in a shorter time, by increasing the intensity. To compare, when the ultraviolet rays in the 313 nm band were used for irradiation, it was found that the VHR characteristic was greatly degraded even for the intensity of about 1 mW, while the intensity on the order of 0.03 mW posed no problem. In other words, it was found that a liquid crystal display device with excellent reliability can be realized by not irradiating ultraviolet rays in the 313 nm band or below.

The ultraviolet ray irradiation according to the present invention may be performed in a state with no application of voltage to the liquid crystal molecules. However, ultraviolet ray irradiation with application of a voltage to the liquid crystal molecules can contribute more to realizing a liquid crystal display device having a high-speed response. This is probably because the state in which a voltage is applied, can quickly come about in the display operation, due to the polymer that was formed while a voltage was applied.

It was found that even when the polymerizable compound according to the present invention was used, adsorption of the polymerizable compound to the liquid crystal layer contacting surface occurred during the filling of the liquid crystal composition into the space of the substrates, generating display unevenness. These display unevenness caused by the filling appear as display unevenness along the direction of flow of the liquid crystal composition, in a system in which the liquid crystal composition is filled from one side of the space between the substrates, and appear as display unevenness in a ring shape, in a system in which the liquid crystal composition is injected dropwise onto the surface of a substrate, followed by bonding the substrate with another substrate.

As a result of investigations, it was found that the problem of the above-described unevenness in adsorption can be prevented by selecting the structure of the liquid crystal layer contacting surface and the constitution of the liquid crystal composition, so that when the liquid crystal composition is disposed between the substrates, the adsorption of a polymer formed by polymerization of the polymerizable compound to the liquid crystal layer contacting surface occurs after the ultraviolet ray irradiation, while the adsorption of the polymerizable compound to the liquid crystal layer contacting surface is hard to occur prior to the ultraviolet ray irradiation. It is also possible to utilize this effect in a more positive way to fill a heated liquid crystal composition into the space between the substrates for disposing the liquid crystal composition between the substrates. It is preferable from the viewpoint of improvement of production and decrease in cost. The substrates may also be heated. It is to be noted that this condition is effective both in the system in which the liquid crystal composition is filled from one side of the space between the substrates, as well as in the system in which the liquid crystal composition is injected dropwise onto the surface of a substrate, followed by bonding the substrate with another substrate.

It is possible to know whether the condition that the adsorption of the polymerizable compound to the liquid crystal layer contacting surface is hard to occur prior to the ultraviolet ray irradiation, and the adsorption of a polymer formed by polymerization of the polymerizable compound to the liquid crystal layer contacting surface occurs after the ultraviolet ray irradiation, is satisfied, by observing the liquid crystal layer in a cross-Nicol arrangement. The following explanation will be made, using a case in which vertical alignment is realized, as an example. When a liquid crystal layer is observed in a cross-Nicol arrangement, light is transmitted, because the liquid crystal molecules are horizontally aligned in a random way, before ultraviolet ray irradiation. On the other hand, after the ultraviolet ray irradiation, the polymerization reaction proceeds, and the occurrence of the vertical alignment of the liquid crystal molecules can be seen through the fact that light is not transmitted. The phrase “after ultraviolet ray irradiation” may mean just after the ultraviolet ray irradiation, or may mean after one or more other treatments such as a heat treatment that follows the ultraviolet ray irradiation.

For the structure of the liquid crystal layer contacting surface for the purpose of realizing a condition that the adsorption of a polymer formed by polymerization of the polymerizable compound to the liquid crystal layer contacting surface occurs after the ultraviolet ray irradiation, while the adsorption of the polymerizable compound to the liquid crystal layer contacting surface is hard to occur prior to the ultraviolet ray irradiation, it is effective to appropriately select the degree of hydrophilicity. An appropriate degree of hydrophilicity can be selected by experiments.

Furthermore, it is also useful to dispose a resin film and use the surface as the liquid crystal layer contacting surface, for the purpose of realizing a condition that when the liquid crystal composition is disposed between the substrates, the adsorption of the polymerizable compound to the liquid crystal layer contacting surface is hard to occur prior to the ultraviolet ray irradiation, and the adsorption of a polymer formed by polymerization of the polymerizable compound to the liquid crystal layer contacting surface occurs after the ultraviolet ray irradiation. For such a resin film, it is effective to appropriately select the degree of hydrophilicity of the resin film. Generally speaking, it is preferable that the surface tension is not less than 42 dyne/cm. Specifically, such a resin film may be appropriately selected from known organic or inorganic resin films. Films of a polyimide resin, novolak resin, and silane resin are examples.

For the constitution of a liquid crystal composition for the purpose of realizing a condition that when the liquid crystal composition is disposed between the substrates, the adsorption of the polymerizable compound to the liquid crystal layer contacting surface is hard to occur prior to the ultraviolet ray irradiation, and the adsorption of a polymer formed by polymerization of the polymerizable compound to the liquid crystal layer contacting surface occurs after the ultraviolet ray irradiation, it is effective to select a suitable composition for the polymerizable compound.

In general, a polymerizable compound according to the present invention is a compound that can form a polymer that exhibits a property of being able to regulate the tilting direction of liquid crystal molecules. It may be a monomer, oligomer or polymer. It may be composed of a single component or a plurality of components. In general, a polymerizable compound consisting of or comprising cross-linkable components is preferable. Examples of cross-linkable components are those having, in a molecule, a plurality of acrylate groups, methacrylate groups, epoxy groups, vinyl groups, allyl groups, and/or other polymerizable functional groups, and having a structural component capable of polymerizing with other molecules through the action of ultraviolet ray irradiation and/or heat.

When a plurality of polymerizable compounds are used as the “polymerizable compound” according to the present invention, it is sufficient if the plurality of polymerizable compounds exhibit, as a whole, a property of being capable of regulating the tilting direction of liquid crystal molecules. The property of being capable of regulating the tilting direction of liquid crystal molecules is not required for each of the compounds. Whether the tilting direction of liquid crystal molecules can be regulated or not, is easily confirmed by actually disposing a liquid crystal composition comprising liquid crystal molecules and a polymerizable compound between two substrates, followed by testing with ultraviolet ray irradiation.

Heat may be applied in the polymerization together with ultraviolet rays. It is considered that the polymer formed by the polymerization is adhered to the liquid crystal layer contacting surface, and the tilting direction of the liquid crystal molecules is regulated by the polymer.

The composition of polymerizable compound for the purpose of realizing a condition that the adsorption of the polymerizable compound to the liquid crystal layer contacting surface is hard to occur prior to the ultraviolet ray irradiation, and the adsorption of a polymer formed by polymerization of the polymerizable compound to the liquid crystal layer contacting surface occurs after the ultraviolet ray irradiation, may be appropriately selected by experiments. In general, a mixture of a monofunctional monomer and a bifunctional monomer is preferable for the compound. It is more preferable to use a mixture with a higher molar concentration of the monofunctional monomer than that of the bifunctional monomer. By selecting such conditions, it is possible to fill the liquid crystal composition, while restraining the adsorption of the polymerizable compound to the substrate surface, and accordingly, fluctuation of the mixing ratio of the polymerizable compound to the liquid crystal can be prevented all over the surface of the panel, and the fluctuation of display characteristics in the liquid crystal panel surface is improved, even if the liquid crystal panel is large.

The liquid crystal composition according to the present invention contains liquid crystal molecules and the above-described polymerizable compound. It is to be noted that the liquid crystal composition may contain, besides these, a polymerization accelerator for accelerating the polymerization caused by ultraviolet ray irradiation and/or heating.

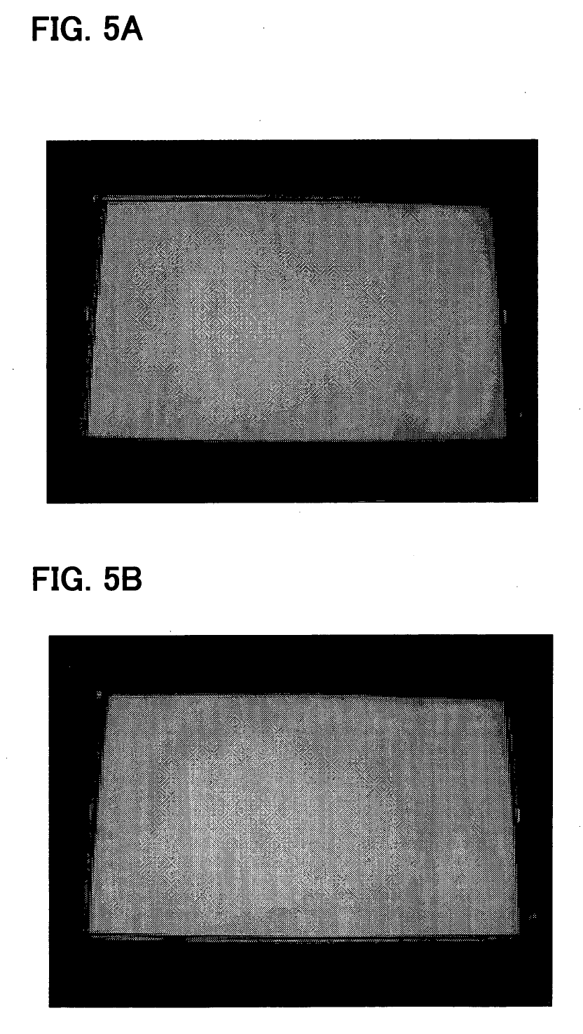

As examples for the embodiment of the present invention, the result (FIG. 5A) of filling a liquid crystal mixed with a mixture of a monofunctional monomer and a bifunctional monomer, while heating them at 60° C., into a blank panel formed by bonding a pair of substrates together, and the result (FIG. 5B) of a heat treatment after the filling at 90° C. (the NI point of the liquid crystal (transition temperature between a nematic liquid crystal phase and an isotropic phase)+20° C.) for 30 minutes are shown. The heat treatment after the filling was for the purpose of alleviating the effect of the flow of the liquid crystal composition at the filling. Both FIGS. 5A and 5B are pictures taken at the observation in a cross-Nicol arrangement using polarizing plates. The pictures show that the liquid crystal was horizontally aligned, the adsorption of the monomers did not occur, and light was transmitted through panel.

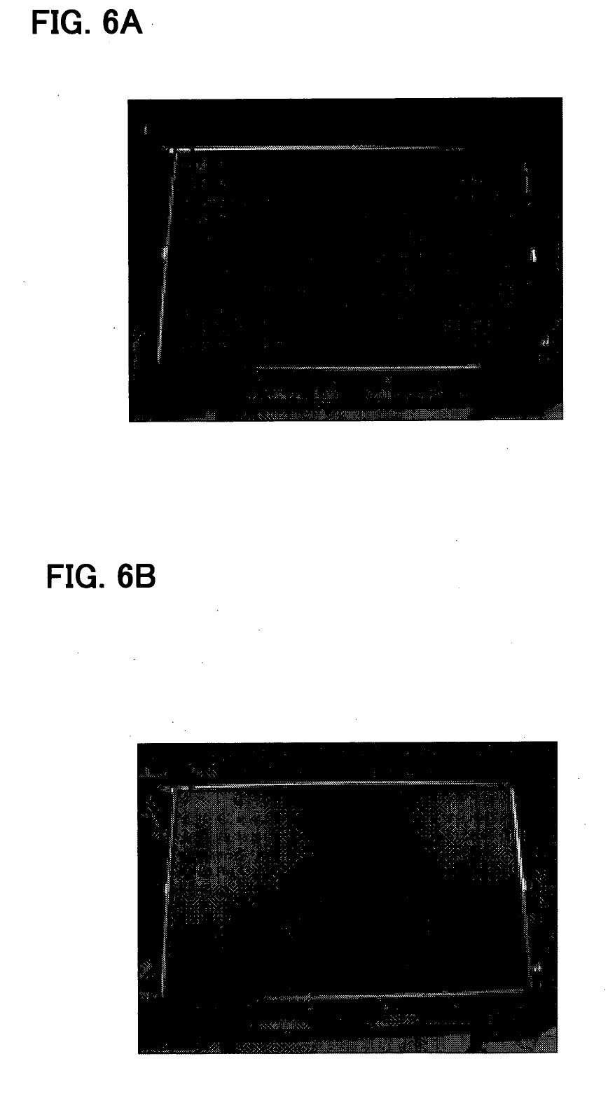

Polarization of light occurred by irradiating this liquid crystal panel with ultraviolet rays (see FIG. 6A). This is because the polymer formed by polymerization of the polymerizable compound caused by ultraviolet ray irradiation, was adsorbed onto the liquid crystal layer contacting surface, and the liquid crystal molecules were regulated by the polymer to be vertically aligned. In addition, more uniform light polarization came about, by performing a heat treatment at 90° C. for 30 minutes, after the ultraviolet ray irradiation (see FIG. 6B). This is because the alignment was made more uniform. It is understood from this that a heat treatment after ultraviolet ray irradiation serves for the uniformization of the alignment. In addition, a second ultraviolet ray irradiation may be conducted after the heat treatment. If, in this case, the second ultraviolet ray irradiation is conducted under the condition of a voltage application, the alignment of liquid crystal molecules can be further regulated, and accordingly, the response speed is improved. It is preferable that the ultraviolet rays used for the second irradiation do not contain the wavelength components not higher than 313 nm.

It was found that in the present invention, if the above-described conditions, particularly the liquid crystal composition, are appropriately selected, the liquid crystal molecules are sufficiently aligned without using an alignment layer, so that an excellent display performance (high VHR, high response speed, etc.) can be realized, which is better than that of a liquid crystal panel manufactured by the conventional manufacturing process in which the alignment layers are formed by printing or the like. By this, cost reduction (material costs and facility costs) and the improvement in the production yield can be realized, and furthermore, a liquid crystal display device having an excellent motion picture display quality can be realized.

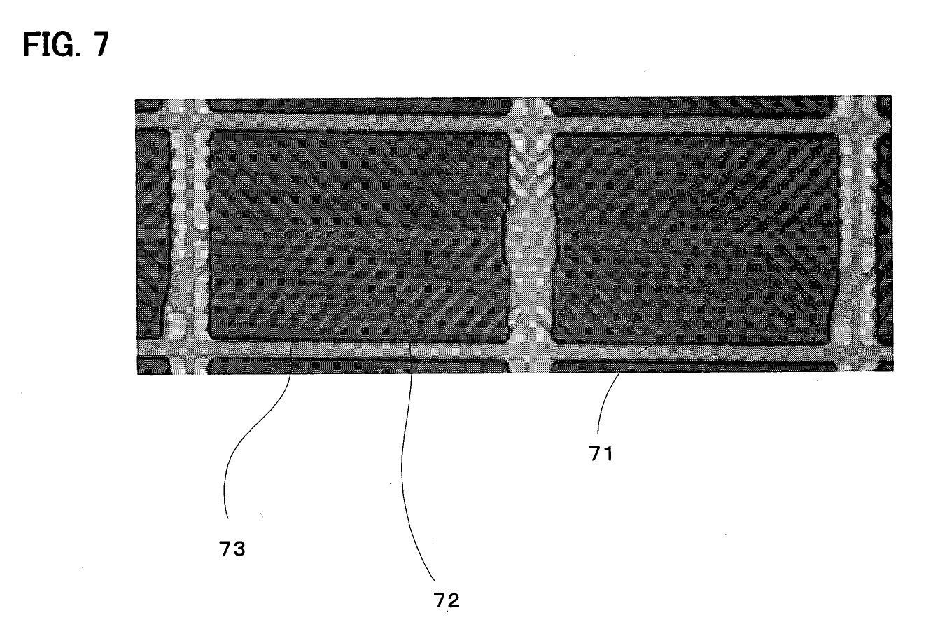

FIG. 7 shows a slit pattern of an ITO electrode of a liquid crystal panel manufactured by forming a blank panel, blending a liquid crystal having a negative dielectric constant anisotropy with a monofunctional acrylate monomer and a bifunctional acrylate monomer at a molar ratio of 10:1, and in an amount of 2% by weight per the liquid crystal, further adding a polymerization initiator, filling the liquid crystal composition thus formed into the space of substrates by the dropping injection method (or one drop filling method), and then performing irradiation with ultraviolet rays that do not contain the wavelength components not higher than 313 nm. No alignment layer was used. FIG. 7 shows two pixels. In FIG. 7, numeral 71 represents the ITO electrode, numeral 72, the slits, and numeral 73, a circuit section. The longer side of the pixel was about 300 μm long.

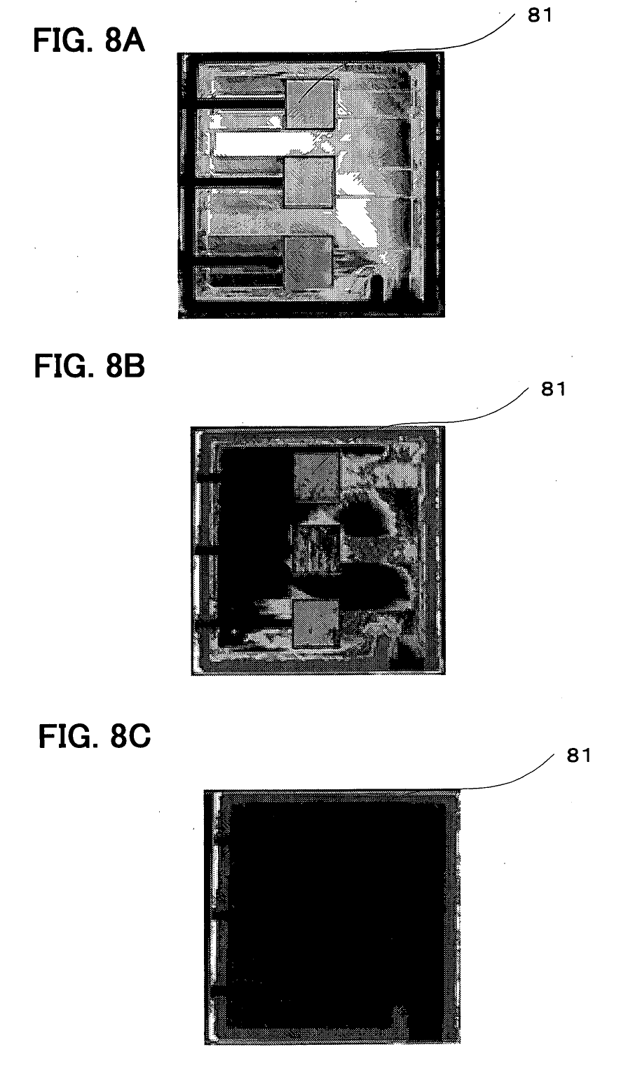

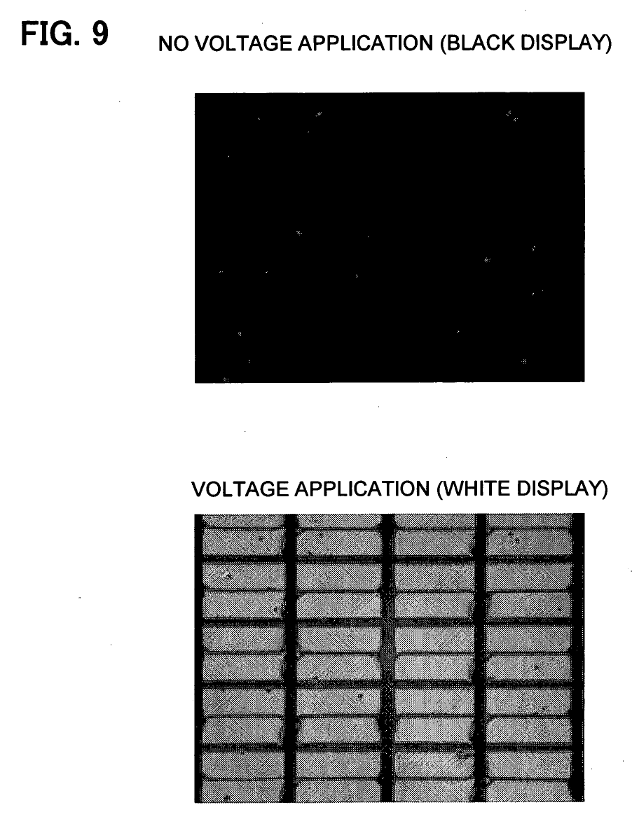

FIGS. 8A to 8C show the results of observation of a liquid crystal panel under this condition in a cross-Nicol arrangement. It is understood that the panel indicated no vertical alignment after the filling of a liquid crystal composition (FIG. 8A). After the ultraviolet ray irradiation, there was not a complete vertical alignment occurred yet (FIG. 8B). Complete vertical alignment occurred by the heat treatment performed afterward (FIG. 8C). It is to be noted that numeral 81 in FIGS. 8A, B and C represents a transparent electrode (1 cm square) installed for the testing in which a multitude of electrode structures as shown in FIG. 7 were formed. It was confirmed from the observation of alignment in black and white displays (FIG. 9), that a uniform vertical alignment was shown, and a multi-domain, wide-viewing-angle liquid crystal panel was realized.

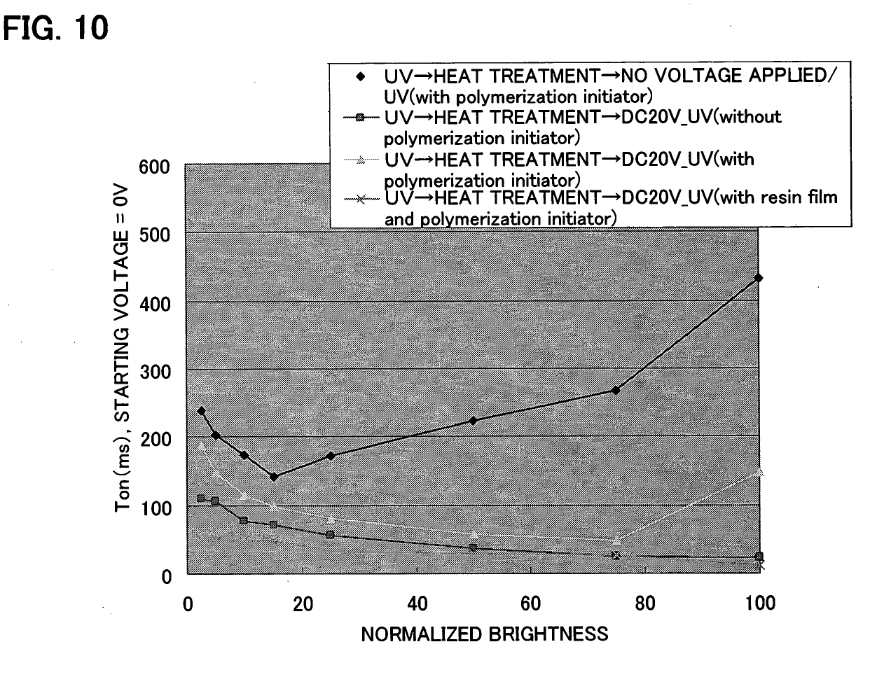

Furthermore, FIG. 10 shows response characteristics when irradiation was performed with ultraviolet rays that did not contain wavelength components not higher than 313 nm, and with a voltage application, for the above-described liquid crystal panel structure. It shows the relationship between the brightness when black is normalized to 0 (zero), and white is normalized to 100, and the response speed (time (millisecond) to reach a specific voltage from 0 V). In any of the cases, after the ultraviolet ray irradiation, a heat treatment was conducted, followed by another round of ultraviolet ray irradiation. Mark ♦ (solid diamond) represents a condition wherein a polymerization initiator was used, and no voltage was applied in the second ultraviolet ray irradiation treatment, mark ▪ (solid square) represents a condition wherein no polymerization initiator was used, and a voltage of 20 V was applied in the second ultraviolet ray irradiation treatment, mark ▴ (solid triangle) represents a condition wherein a polymerization initiator was used, and a voltage of 20 V was applied in the second ultraviolet ray irradiation treatment, and mark X represents a condition wherein a polymerization initiator was used, a voltage of 20 V was applied in the second ultraviolet ray irradiation treatment, and a resin film according to the present invention was used in addition. A polyimide resin was used for the resin film.

From these results, it is understood that a high response speed was obtained for the liquid crystal panels for which ultraviolet rays were irradiated in a voltage application state (DC 20 V), compared with the panels for which no voltage was applied. Similar effect of voltage application can be obtained if a voltage is applied during the first ultraviolet ray application treatment.

The reason is considered to be that the structure of the polymer was transformed according to the alignment direction of liquid crystal molecules, by irradiating ultraviolet rays in a state in which a voltage was applied to the pixel electrodes to regulate the alignment direction of the liquid crystal molecules, giving the liquid crystal molecules pretilting angles in the alignment directions.

Regarding the presence/absence of the polymerization initiator, those without the polymerization initiator showed a higher response speed. The reason is considered to be that when the polymerization initiator was absent, the polymerization velocity was smaller, and accordingly, a film with a higher degree of polymerization was formed. It was found that when the same composition was used for the polymerizable compound, the resin film according to the present invention contributed to a higher response.

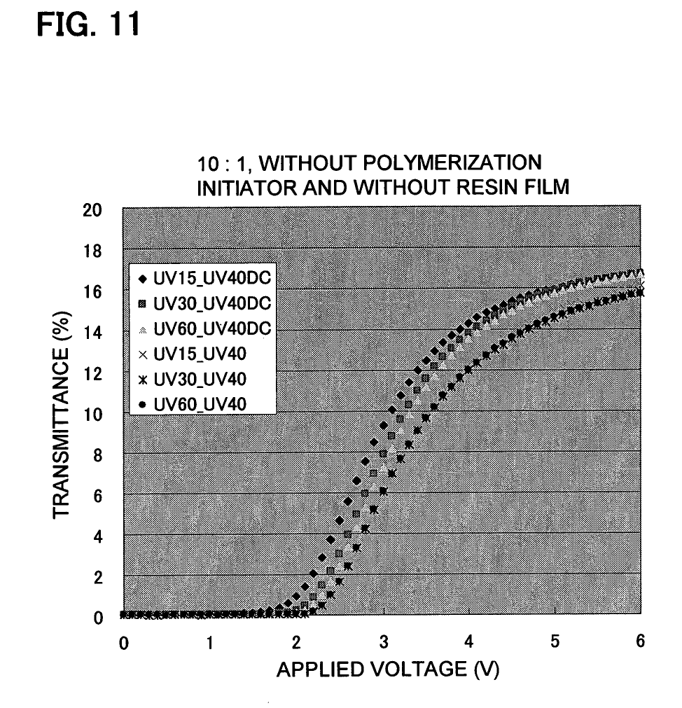

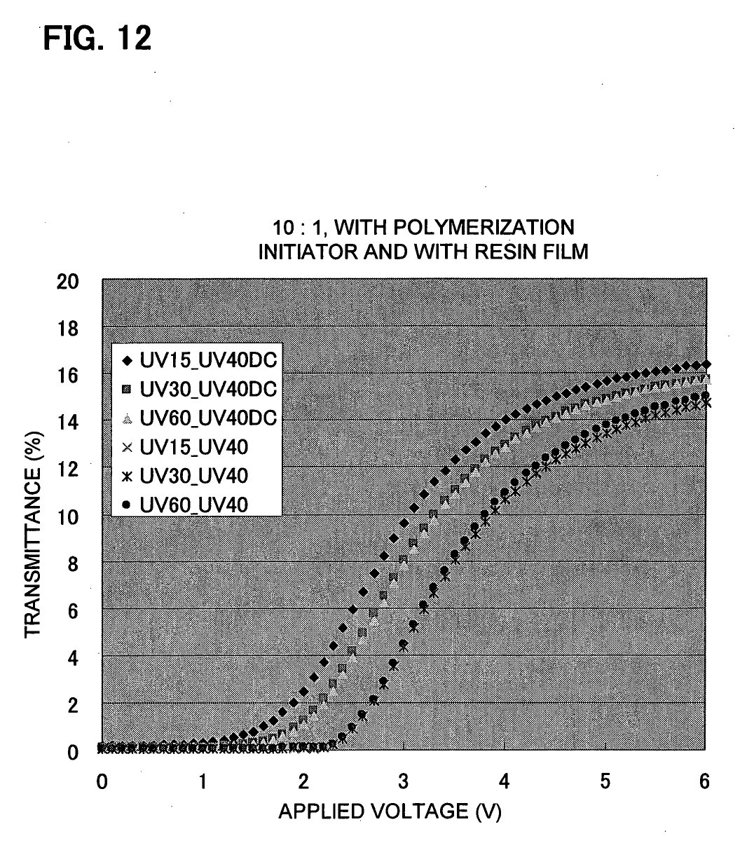

In addition, it was found as a result of the above-described investigations that the switching characteristics (voltage-transmission characteristics) of liquid crystal molecules can be changed by the compositional conditions of the polymerizable compound, ultraviolet ray irradiation conditions, voltage application conditions, heat treatment conditions, resin film formation conditions according to the present invention, etc., as shown in FIGS. 11 and 12 that will be described later. Therefore, if different switching characteristics (voltage-transmission characteristics) of liquid crystal molecules are realized within one pixel by utilizing this, it is possible, for example, to realize an optimum switching characteristic for each subpixel for color displaying, and to realize a liquid crystal display device having high display quality with a smaller viewing angle dependency of chromatic characteristics. Hereupon, the phrase “different switching characteristics within one pixel” includes a case where there are different characteristics within one subpixel, as well as a case where each subpixel has a different characteristic.

As described above, the liquid crystal display device according to the present invention can be manufactured at a low cost and a high production yield, and it is possible to realize a liquid crystal display device having a wide viewing angle, little viewing angle dependency, and a high response speed. Furthermore, since it is possible to form a liquid crystal panel without installing alignment layers in some cases, it will be easier to accommodate the need for jumboization of liquid crystal panels.

### EXAMPLES

Next, the present invention will be explained in detail in reference to the following examples.

### Example 1

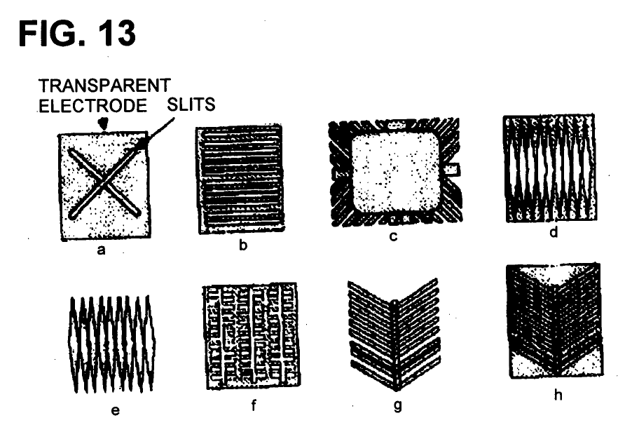

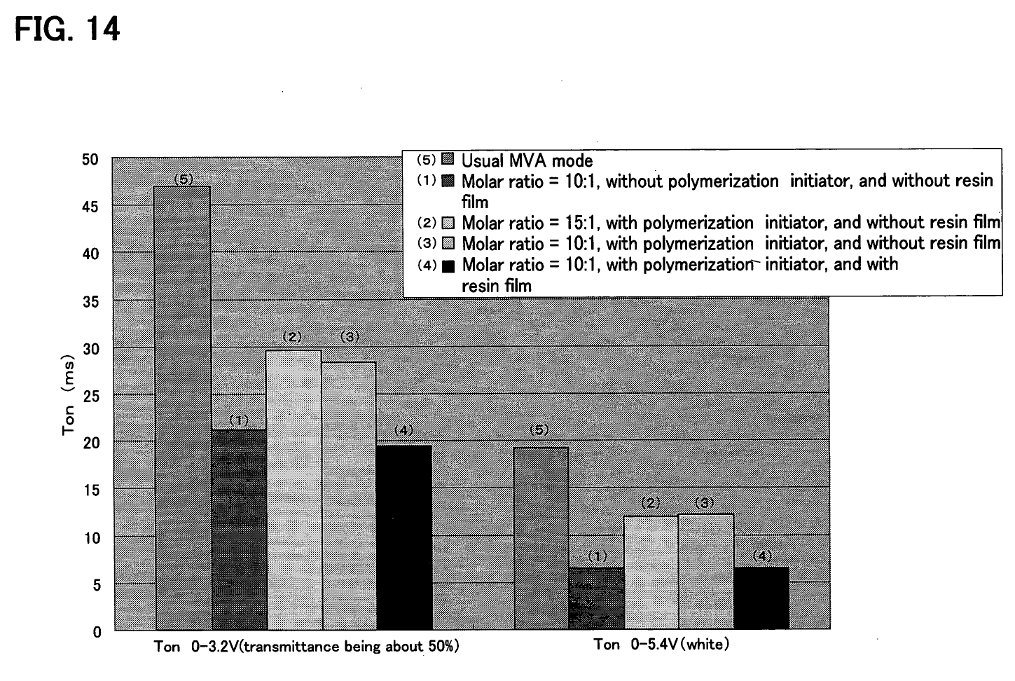

As a slit pattern of an electrode according to the present invention, those in FIG. 13 are examples. The letters a to h in FIG. 13 show patterns each for one pixel. The optical characteristics of a liquid crystal panel manufactured, using the electrode structure shown in letter f of FIG. 13 are shown in FIG. 14.

In FIG. 14, (1) is a case for a liquid crystal panel under conditions of the molar ratio being 10:1, a polymerization initiator being absent, and a resin film according to the present invention being absent; (2) is a case for a liquid crystal panel under conditions of the molar ratio being 15:1, a polymerization initiator being present, and a resin film according to the present invention being absent; (3) is a case for a liquid crystal panel under conditions of the molar ratio being 10:1, a polymerization initiator being present, and a resin film according to the present invention being absent; (4) is a case for a liquid crystal panel under conditions of the molar ratio being 10:1, a polymerization initiator being present, and a resin film according to the present invention being present (a polyimide resin was used for the resin film), and (5) is a case for a usual MVA-mode liquid crystal panel for comparison. In (5), the electrode structure having a protrusion pattern shown in FIG. 2 was used.

After the formation of blank panels, the following treatments were performed regarding cases (1) to (4): a liquid crystal having a negative dielectric constant anisotropy was blended with a monofunctional acrylate monomer and a bifunctional acrylate monomer at a molar ratio of 10:1 or 15:1, the monomers being in an amount of 2% by weight per the liquid crystal; the mixtures thus formed were filled between pairs of substrates by the dropping injection method; subjected to a first irradiation with ultraviolet rays that did not contain wavelength components not higher than 313 nm; subjected to a heat treatment at 90° C., a temperature that was not less than the NI point of the liquid crystal, for 30 minutes; and then subjected to a second irradiation with ultraviolet rays that did not contain wavelength components not higher than 313 nm, with a voltage application. In this example, DC 20 V was applied. A rectangular AC voltage may be applied, instead. It is sufficient if the applied voltage is not less than the threshold voltage of the liquid crystal. A voltage not less than the voltage for the white display is preferable since it furnishes a larger pretilting angle and a higher response speed.

From the results of the response characteristics shown in FIG. 14, it is understood that the liquid crystal panels according to the present invention showed higher response speeds than the standard MVA-mode liquid crystal panel (5) having the same cell thickness in which usual vertical aligning control films were used. It is to be noted that those without a polymerization initiator had higher response speeds. It is also understood from the comparison of cases under the same polymerization condition (all having a polymerization initiator) that a case in which a resin film had been formed on the surface of the substrate beforehand showed a higher response speed.

### Example 2

FIGS. 11 and 12 show the voltage-transmission characteristics of liquid crystal panels under conditions (3) and (4) described in EXAMPLE 1. In FIGS. 11 an 12, the phrase “UV15, UV40DC” means that the first ultraviolet ray irradiation was performed for the duration of 15 minutes, and the second ultraviolet ray irradiation was performed for the duration of 40 minutes under a voltage application of DC 10 V; the phrase “UV30, UV40DC” means that the first ultraviolet ray irradiation was performed for the duration of 30 minutes, and the second ultraviolet ray irradiation was performed for the duration of 40 minutes under a voltage application of DC 10 V; the phrase “UV60, UV40DC” means that the first ultraviolet ray irradiation was performed for the duration of 60 minutes, and the second ultraviolet ray irradiation was performed for the duration of 40 minutes under a voltage application of DC 10 V; the phrase “UV15, UV40” means that the first ultraviolet ray irradiation was performed for the duration of 15 minutes, and the second ultraviolet ray irradiation was performed for the duration of 40 minutes without a voltage application; the phrase “UV30, UV40” means that the first ultraviolet ray irradiation was performed for the duration of 30 minutes, and the second ultraviolet ray irradiation was performed for the duration of 40 minutes without a voltage application; and the phrase “UV60, UV40” means that the first ultraviolet ray irradiation was performed for the duration of 60 minutes, and the second ultraviolet ray irradiation was performed for the duration of 40 minutes without a voltage application.

From FIGS. 11 and 12, it is understood that it is possible to change the voltage-transmission characteristics, by changing ultraviolet ray irradiation conditions. It was also confirmed that it is possible to change the voltage-transmission characteristics, by changing voltage application conditions. From the comparison of FIGS. 11 and 12, it is also understood that the threshold voltage can also be changed greatly, by forming a resin film according to the present invention on the substrate surface beforehand. It is to be noted that the term “threshold voltage” means the voltage at which a liquid crystal starts to transmit light, and the voltage when the transmittance is 10% of the saturated transmittance is used as the threshold voltage in the present invention.

The reason that the threshold voltage can be changed greatly is that the pretilting angle of a liquid crystal is dependent on the process parameters including the compositional conditions of the polymerizable compound, the ultraviolet ray irradiation conditions, the voltage application conditions, heat treatment conditions, and film formation conditions of the resin film according to the present invention. This means that the pretilting angle can be controlled by changing these parameters.

It was possible to realize a liquid crystal display device having high display quality with very little color drift and with little viewing angle dependency of color characteristics, by utilizing this behavior, that is, by varying the switching characteristics of liquid crystal molecules (voltage-transmittance characteristics) within one pixel (or within one subpixel), through selection of the kind and/or combination of polymerizable compounds for use, ultraviolet ray irradiation conditions, voltage application conditions, resin film formation conditions, or the like. As the resin film formation conditions, adjusting the surface tension of the resin film, and forming the resin film partly, for example as a pattern, on the liquid crystal layer contacting surface but not wholly on the surface, are examples.

### Example 3

The conditions for (1) of EXAMPLE 1 were adopted, except that a visible light-curable sealant was used as a sealant for the bonding and sealing works for the liquid crystal panel, instead of a conventional UV-curable sealant. Employing this condition will enhance the freedom in the production, since there will be no problem of curing of the liquid crystal composition during the curing of the sealant. A TFT-driven liquid crystal display device having a wide viewing angle and a high response speed was realized.

### Example 4

A liquid crystal having a negative dielectric constant anisotropy was blended with a monofunctional acrylate monomer and a bifunctional acrylate monomer at a molar ratio of 10:1, the monomers being in an amount of 2% by weight per the liquid crystal. The liquid crystal composition thus formed was filled into a TFT-driven liquid crystal panel in vacuo from the side, subjected to irradiation with ultraviolet rays that did not contain wavelength components not higher than 313 nm, with the pixel voltage driven by the TFT being increased, starting at 0 V, and then subjected to a heat treatment at 90° C. for 30 minutes. A TFT-driven liquid crystal display device having a wide viewing angle and a high response speed was realized. The reason of increasing the pixel voltage from 0 V, instead of applying the required voltage quickly is that in some cases, the alignment of liquid crystal molecules is disturbed by a quick voltage application.

### Example 5

Blank panels were prepared that were composed of a substrate (TFT-side substrate) on which TFT's by the lateral electric field driving system were implemented, and a counter substrate (CF-side substrate) on the surface of which nothing was installed or on the CF (color filter) of which a resin film according to the present invention was formed. In the lateral electric field driving system, electrodes for controlling the electric field are formed only on one of the surface of substrates that face each other. A liquid crystal having a negative dielectric constant anisotropy was blended with a monofunctional acrylate monomer and a bifunctional acrylate monomer at a molar ratio of 10:1, the monomers being in an amount of 2% by weight per the liquid crystal. A polymerization initiator was further added to form a liquid crystal composition. The liquid crystal composition thus formed was filled into the liquid crystal panels in vacuo from the side, and the liquid crystal panel was subjected to the first irradiation with ultraviolet rays that did not contain wavelength components not higher than 313 nm, subjected to a heat treatment at 90° C. for 30 minutes, and then subjected to the second irradiation through the TFT-side substrates with ultraviolet rays that did not contain wavelength components not higher than 313 nm, with the pixel voltage driven by the TFT's being increased, starting at 0 V. In both cases, TFT-driven liquid crystal display devices having a wide viewing angle and a high response speed were realized. The second ultraviolet irradiation may be conducted through the CF-side substrates.

### Example 6

Blank panels were prepared that were composed of a TFT-side substrate with TFT's by the lateral electric field driving system, and a counter, CF-side substrate on the surface of which nothing was installed or on the CF of which a resin film according to the present invention was formed. A liquid crystal having a positive dielectric constant anisotropy was blended with a monofunctional acrylate monomer and a bifunctional acrylate monomer at a molar ratio of 10:1, the monomers being in an amount of 2% by weight per the liquid crystal. A polymerization initiator was further added to form a liquid crystal composition. The composition thus formed was filled into the liquid crystal panels in vacuo from the side, and the liquid crystal panels were subjected to the first irradiation with ultraviolet rays that did not contain wavelength components not higher than 313 nm, subjected to a heat treatment at 90° C. for 30 minutes, and then subjected to the second irradiation through the TFT-side substrates with ultraviolet rays that did not contain wavelength components not higher than 313 nm, with a voltage application driven by the TFT's. In both cases, liquid crystal panels (VA-IPS mode) having a wide viewing angle and a high response speed were prepared at a low cost.

### Example 7

A liquid crystal having a negative dielectric constant anisotropy was blended with a monofunctional acrylate monomer and a bifunctional acrylate oligomer at a molar ratio of 10:1, the monomers being in an amount of 2% by weight per the liquid crystal. A polymerization initiator was further added to form a liquid crystal composition. The composition thus formed was filled into a liquid crystal panel by the dropping injection method. After a TFT-driven liquid crystal panel was formed, it was subjected to the first irradiation through the TFT-side substrate with ultraviolet rays that did not contain wavelength components not higher than 313 nm, subjected to a heat treatment at 90° C. for 30 minutes, and then subjected to the second irradiation through the TFT-side substrate with ultraviolet rays that did not contain wavelength components not higher than 313 nm, with a voltage application driven by the TFT. A liquid crystal panel (MVA-mode) having a wide viewing angle and a high response speed was prepared at a low cost.

What is claimed is:

1. A liquid crystal display device, wherein:
a liquid crystal composition comprising liquid crystal molecules and a polymerizable compound that can be polymerized by ultraviolet rays or by a combination of ultraviolet rays and heat is disposed between a pair of substrates;
said polymerizable compound is polymerized, forming a liquid crystal layer, by an operation comprising irradiation of ultraviolet rays that do not contain wavelength components of not higher than 313 nm; and
protrusions, recessions, or protrusions and recessions are installed on a liquid crystal layer contacting surface; or
a slit pattern is installed in an electrode; or
protrusions, recessions, or protrusions and recessions are installed on the liquid crystal layer contacting surface, and a slit pattern is installed in the electrode.

2. A liquid crystal display device according to claim 1, wherein a voltage is applied to said liquid crystal molecules at the time of said ultraviolet ray irradiation.

3. A liquid crystal display device according to claim 1, wherein the structure of said liquid crystal layer contacting surface and the constitution of said liquid crystal composition are selected, so that when said liquid crystal composition is disposed between said substrates, the adsorption of a polymer formed by polymerization of the polymerizable compound to said liquid crystal layer contacting surface occurs after said ultraviolet ray irradiation, while the adsorption of the polymerizable compound to said liquid crystal layer contacting surface is hard to occur prior to said ultraviolet ray irradiation.

4. A liquid crystal display device according to claim 3, wherein a resin film is disposed, and the surface is used as said liquid crystal layer contacting surface, so that when said liquid crystal composition is disposed between said substrates, the adsorption of a polymer formed by polymerization of the polymerizable compound to said liquid crystal layer contacting surface easily occurs after said ultraviolet ray irradiation, while the adsorption of the polymerizable compound to said liquid crystal layer contacting surface is hard to occur prior to said ultraviolet ray irradiation.

5. A liquid crystal display device according to claim 3, wherein said liquid crystal composition is filled into the space between said substrates in a heated state, when disposing said liquid crystal composition between said substrates.

6. A liquid crystal display device according to claim 1, wherein a mixture of a monofunctional monomer and bifunctional monomer is used as said polymerizable compound.

7. A liquid crystal display device according to claim 6, wherein a mixture in which the molar concentration of said monofunctional monomer is higher than that of said bifunctional monomer, is used.

8. A liquid crystal display device according to claim 1, wherein said operation including the ultraviolet ray irradiation, includes ultraviolet ray irradiation and a heat treatment thereafter.

9. A liquid crystal display device according to claim 8, wherein said operation including the ultraviolet ray irradiation, includes a second ultraviolet ray irradiation after said heat treatment.

10. A liquid crystal display device according to claim 1, wherein said liquid crystal molecules have different switching characteristics (voltage-transmittance characteristics) within one pixel.

11. A liquid crystal display device according to claim 10, wherein at least one condition selected from the group consisting of compositional conditions of said polymerizable compound, ultraviolet ray irradiation conditions, voltage application conditions, heat treatment conditions, and formation conditions of a resin film according to the present invention, is changed within one pixel.

12. A liquid crystal display device according to claim 1, wherein said liquid crystal molecules have a negative dielectric constant anisotropy.
